(19) United States
(12) Patent Application Publication
(10) Pub. No.: US 2002/0146594 A1
(43) Pub. Date: Oct. 10, 2002

(54) Magnetic recording medium and production method thereof and magenetic recording device

(75) Inventors: Migaku Takahashi, Sendai-Shi (JP); David Djayaprawira, Sendai-Shi (JP); Masaki Mikami, Sendai-Shi (JP)

Correspondence Address: YOUNG & THOMPSON, 745 SOUTH 23RD STREET 2ND FLOOR, ARLINGTON, VA, 22202

(73) Assignee: MIGAKU TAKAHASHI, SENDAI-SHI (JP)

(21) Appl. No.: 10/052,357

(22) Filed: Jan. 23, 2002

(30) Foreign Application Priority Data
Jan. 25, 2001 (JP) 2001-017112

(51) Int. Cl. G11B 5/66

(52) U.S. Cl. 428/694 TS

(57) ABSTRACT

A magnetic recording medium with a favorable S/N ratio, for which a high coercive force is possible, as well as a method of producing such a medium, and a magnetic recording device which utilizes such a medium. The magnetic recording medium includes a non-magnetic substrate, and a nucleation layer, a metal underlayer, and a ferromagnetic metal layer for recording magnetic information formed either directly or indirectly on top of the non-magnetic substrate, wherein the nucleation layer includes either an alloy incorporating at least Nb, or an alloy incorporating at least one element selected from the group consisting of V, Mo and W. Moreover, the nucleation layer should preferably also include at least one element selected from the group consisting of Ni, Co, Fe and Cu. The magnetic recording medium according to the present invention can be ideally applied to hard disks, floppy disks, and magnetic tapes and the like.

### BACKGROUND OF THE INVENTION

1. Field of the Invention

The present invention relates to a magnetic recording medium, a production method thereof, and a magnetic recording device, and more particularly to a magnetic recording medium in which the recording and playback characteristics such as the S/N ratio have been improved by providing a seed layer with superior characteristics, as well as a production method thereof, and a magnetic recording device provided with such a magnetic recording medium. The magnetic recording medium of the present invention can be ideally applied to hard disks, floppy disks, and magnetic tapes and the like.

2. Description of the Related Art

In recent years, magnetic recording media have been widely used as high density, large capacity recording media in devices such as hard disks, although improvements are now required in recording and playback characteristics in order to achieve even higher densities.

FIG. 10 and FIG. 11 are schematic illustrations showing a hard disk as an example of a magnetic recording medium.

FIG. 10 is a perspective view of a disc shaped magnetic recording medium, and FIG. 11 is a cross-sectional view along the line A-A shown in FIG. 10.

A magnetic recording medium 90 shown in FIG. 10 comprises a disc shaped substrate 92 of a non-magnetic material, a seed layer 93 formed on top of this substrate 92, and then a metallic underlayer 94, a ferromagnetic metal layer 95 and a protective layer 96 formed thereon.

In the magnetic recording medium 90 of this example, a seed layer 93 comprising Ni—Al is provided on the surface of a non-magnetic substrate 92 comprising glass or the like. A metal underlayer 94 of Cr or a Cr alloy for example, a ferromagnetic metal layer 95 comprising a magnetic film of CoCrTa or CoCrPtB, and a protective layer 96 of carbon or the like are then layered sequentially on top of this substrate 92. Typical thickness values for each of these layers are 25 nm to 100 nm for the seed layer 93, 10 nm to 30 nm for the metal underlayer (Cr) 94, 15 nm to 50 nm for the ferromagnetic metal layer (Co based ferromagnetic alloy) 95, and 3 nm to 40 nm for the protective layer 96. Although not shown in the drawings, a coating of a fluorine based lubricant such as perfluoro polyether may also be provided on top of the protective layer 96.

In a magnetic recording medium with a glass substrate 92 such as that described above, the crystal orientation of the metal underlayer 94 and the ferromagnetic metal layer 95 will differ significantly from that of a metal underlayer and a ferromagnetic metal layer formed on a NiP—Al substrate. Specifically, the orientation of a metal underlayer of Cr or a Cr alloy formed at a high temperature on a NiP—Al substrate is typically (100), and the orientation of a ferromagnetic metal layer of a cobalt based ferromagnetic alloy formed on the surface of the oriented metal underlayer is (110) with the c axis in a direction within the plane of the substrate. In contrast, if a metal underlayer and a ferromagnetic metal layer are formed on top of a glass substrate under identical conditions, then the layers will display different crystal orientations from the layers formed on the NiP—Al substrate described above, and as a result, the recording and playback characteristics will be inferior.

Consequently, in the above type of magnetic recording medium with a glass substrate 91, a seed layer 93 is provided in order to control the crystal orientation and the crystal grain diameter.

In the above type of magnetic recording medium, by providing a layer of a material comprising a NiAl seed layer 93 between the metal underlayer 94 and the substrate 92, the crystal grains of the ferromagnetic metal layer 95 which represents the recording layer are miniaturized, and the noise level of the magnetic recording medium is reduced. According to a magnetic recording medium of this type of construction, within the Co based ferromagnetic alloy of the ferromagnetic metal layer, the c axis of an hcp structure is able to be oriented in a substantially parallel arrangement with the substrate 92 (“The Control and Characterization of the Crystallographic Texture of Longitudinal Thin Film Recording Media”, IEEE Trans. Magnetic. 32 (5), 1996, 3632).

Conventional magnetic recording media such as the medium described above offer significant improvements in the recording and playback characteristics when compared with magnetic recording media with no seed layer 93, but in order to achieve higher recording densities on magnetic recording media, improvements in noise characteristics are essential, and in order to reduce the noise level of a medium, the crystal grains of the ferromagnetic metal layer 95 must be further miniaturized.

However, in cases such as that described above, where NiAl is provided as a seed layer 93, then as can be seen in the graph of FIG. 9, unless the film thickness of the NiAl seed layer 93 is quite large, a high coercive force cannot be obtained. FIG. 9 is a graph showing the coercive force of a magnetic recording medium relative to the film thickness of the NiAl seed layer 93.

It is believed that this observation is due to the fact that the uniformity of the crystallographic orientation plane of the NiAl seed layer 93 is not necessarily favorable, and as a result the crystallographic orientation plane of the metal underlayer 94 also lacks uniformity, meaning that the growth of crystal grains with an crystallographic orientation plane which will exhibit a high coercive force value is inhibited. With the above type of NiAl seed layer 93, in which a large film thickness is necessary to achieve a high coercive force, the crystal grains of the metal underlayer 94 formed on top of the seed layer will increase in size, making it impossible to miniaturize the crystal grains of the ferromagnetic metal layer 95, and consequently making a reduction in the noise level also unachievable.

### SUMMARY OF THE INVENTION

The present invention takes the above circumstances into consideration, with an object of providing a magnetic recording medium with a favorable S/N ratio, in which a high coercive force is achievable even with a thin seed layer, as well as a method of producing such a medium, and a magnetic recording device which utilizes such a medium.

In order to achieve the above object, the present invention employs the configuration described below.

A magnetic recording medium according to the present invention comprises a non-magnetic substrate, and a nucleation layer, a metal underlayer, and a ferromagnetic metal layer for recording magnetic information, formed either directly or indirectly on top of the non-magnetic substrate, wherein the nucleation layer comprises an alloy incorporating at least Nb.

In a magnetic recording medium according to the present invention, the proportion of Nb within the aforementioned nucleation layer should preferably be from 20 at % to 80 at %.

Furthermore, in a magnetic recording medium according to the present invention, a proportion of Nb within the aforementioned nucleation layer from 30 at % to 50 at % is even more desirable.

In addition, another magnetic recording medium according to the present invention comprises a non-magnetic substrate, and a nucleation layer, a metal underlayer, and a ferromagnetic metal layer for recording magnetic information, formed either directly or indirectly on top of the non-magnetic substrate, wherein the nucleation layer comprises an alloy incorporating at least one element selected from the group consisting of V, Mo and W.

In a magnetic recording medium according to the present invention, the proportion of V, Mo or W within the aforementioned nucleation layer should preferably be from 20 at % to 80 at %.

Furthermore, in a magnetic recording medium according to the present invention, a proportion of V, Mo or W within the aforementioned nucleation layer from 30 at % to 50 at % is even more desirable.

In addition, in yet another magnetic recording medium according to the present invention, the aforementioned nucleation layer comprises at least one material selected from the group consisting of Ni, Co, Fe and Cu.

Furthermore, in a magnetic recording medium according to the present invention, the film thickness of the aforementioned nucleation layer is from 2.5 nm to 500 nm.

A method of producing a magnetic recording medium according to the present invention comprises steps for forming, by film fabrication methods, at least a nucleation layer, a metal underlayer, and a ferromagnetic metal layer on top of a non-magnetic substrate, wherein the nucleation layer is fabricated from an alloy incorporating at least Nb, and a step is provided for physically adsorbing oxygen and/or nitrogen onto at least the surface of the nucleation layer.

In addition, another method of producing a magnetic recording medium according to the present invention comprises steps for forming, by film fabrication methods, at least a nucleation layer, a metal underlayer, and a ferromagnetic metal layer on top of a non-magnetic substrate, wherein the nucleation layer is fabricated from an alloy incorporating at least one element selected from the group consisting of V, Mo and W, and a step is provided for physically adsorbing oxygen and/or nitrogen onto at least the surface of the nucleation layer.

Furthermore, in a method of producing a magnetic recording medium according to the present invention, the gas used for film fabrication of the aforementioned nucleation layer is a mixed gas comprising Ar or another rare gas to which oxygen or nitrogen has been added.

Furthermore in a method of producing a magnetic recording medium according to the present invention, the aforementioned step for physically adsorbing oxygen and/or nitrogen onto at least the surface of the aforementioned nucleation layer is a step for exposing the surface of the nucleation layer to an atmosphere incorporating oxygen and/or nitrogen.

Furthermore in a method of producing a magnetic recording medium according to the present invention, the amount of oxygen exposure on the surface of the aforementioned nucleation layer is at least 25 Langmuir.

In addition, in yet another method of producing a magnetic recording medium according to the present invention, at least one layer amongst the nucleation layer, the metal underlayer and the ferromagnetic metal layer is fabricated in a film fabrication chamber with an ultimate vacuum of no more than 3×10⁻⁹ Torr (=2.4×10⁻⁷ Pa), using a film fabrication gas with an impurity concentration of no more than 1 ppb.

A magnetic recording device according to the present invention comprises a magnetic recording medium as described above, a drive section for driving the magnetic recording medium, and a magnetic head for carrying out recording and playback of magnetic information, wherein the magnetic head performs recording and playback of magnetic information on the moving aforementioned magnetic recording medium.

As described above in detail, by constructing a magnetic recording medium comprising a nucleation layer, a metal underlayer, and a ferromagnetic metal layer for recording magnetic information, formed either directly or indirectly on top of a non-magnetic substrate, wherein the nucleation layer comprises either an alloy incorporating at least Nb, or an alloy incorporating at least one element selected from the group consisting of V, Mo and W, a magnetic recording medium can be provided which displays both a high coercive force and a superior S/N ratio.

In addition, in a method of producing a magnetic recording medium according to the present invention comprising steps for forming, by film fabrication methods, at least a nucleation layer, a metal underlayer, and a ferromagnetic metal layer on top of a non-magnetic substrate, because the nucleation layer is fabricated from an alloy incorporating at least one element selected from the group consisting of Nb, V, Mo and W, and a step is provided for physically adsorbing oxygen and/or nitrogen onto at least the surface of the nucleation layer, the crystal grains of the metal underlayer formed on top of the nucleation layer can be miniaturized and formed with greater uniformity. As a result, the crystal grains of the ferromagnetic metal layer, which functions as the recording layer, formed on top of the metal underlayer can also be miniaturized and formed with greater uniformity, and so a method of stably producing a magnetic recording medium with a superior S/N ratio can be provided.

Furthermore, a magnetic recording device comprising a magnetic recording medium with superior magnetic characteristics as described above, is able to provide a high S/N ratio and superior recording and playback characteristics.

### BRIEF DESCRIPTION OF THE DRAWINGS

FIG. 1 is a diagram showing a schematic representation of the cross-sectional structure of a magnetic recording medium of an embodiment of the present invention.

FIG. 2 is a diagram showing the temperature characteristics of the standard free energy of formation for certain oxides.

FIG. 3 is a diagram showing the magnetic characteristics of an Example 1 of the present invention.

FIG. 4 is a diagram showing the recording and playback characteristics of the Example 1 of the present invention.

FIG. 5 is a diagram showing the magnetic characteristics of an Example 2 of the present invention.

FIG. 6 is a diagram showing the recording and playback characteristics of the Example 2 of the present invention.

FIG. 7 is a side view showing an example of a magnetic recording device according to the present invention.

FIG. 8 is a plan view of the magnetic recording device shown in FIG. 7.

FIG. 9 is a diagram showing the magnetic characteristics of a conventional hard disk as an example of a magnetic recording medium.

FIG. 10 is a perspective view showing a conventional hard disk as an example of a magnetic recording medium.

FIG. 11 is a diagram showing a schematic representation of the cross-sectional structure of a conventional hard disk as an example of a magnetic recording medium.

Brief Description of the Reference Symbols

1 Substrate (non-magnetic)

2 Seed layer (nucleation layer)

3 Metal underlayer

4 Ferromagnetic metal layer

### DETAILED DESCRIPTION OF THE PREFERRED EMBODIMENTS

As follows is a description of embodiments of the present invention with reference to the drawings.

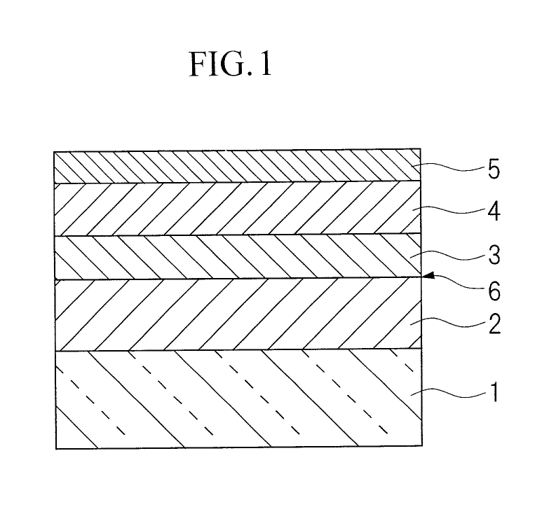

FIG. 1 is a diagram showing a schematic representation of the cross-sectional structure of an embodiment of a magnetic recording medium of the present invention which has been adapted for use as a hard disk in a computer. In the diagram, a magnetic recording medium is constructed of a seed layer (nucleation layer) 2, a metal underlayer 3, a ferromagnetic metal layer 4, and a protective layer 5 formed sequentially on top of a substrate 1 comprising a disc shaped non-magnetic material. Furthermore, oxygen has been physically adsorbed at the interface 6 between the seed layer 2 and the metal underlayer 3.

The layered structure of the magnetic recording medium of this embodiment shown in FIG. 1 is the basic structure for a magnetic recording medium according to the present invention, and structures in which other intermediate layers are provided, as necessary, between the substrate 1 and the protective layer 5, are possible, as are structures in which the metal underlayer 3 comprises a number of at least 2 layers. Furthermore, a lubrication layer of a fluorine based lubricant may also be provided on top of the protective layer 5.

As follows is a more detailed description of a magnetic recording medium according to the present invention.

(Substrate)

The substrate 1 according to the present invention can utilize materials such as aluminum or an alloy or oxide thereof, titanium or an alloy or oxide thereof, or silicon, glass, carbon, ceramic, plastic, resin, or a complex of such materials. Furthermore, a surface coating comprising a non-magnetic layer of a different material may also be formed on the surface of the aforementioned substrate using either sputtering, vapor deposition, or plating techniques.

In those cases in which a non-magnetic layer is provided on the surface of the substrate 1, the non-magnetic material should preferably not undergo magnetization at high temperatures, should display conductivity and be easily tooled mechanically, and yet also offer a suitable degree of surface hardness. Examples of preferred non-magnetic materials which satisfy these conditions include, in particular, Ni—P films prepared by plating techniques.

Glass substrates, which can be produced with an extremely smooth surface at low cost, and which can be used in high temperature processes, are particularly suited for magnetic recording media according to the present invention.

In terms of the shape of the substrate 1, in the case of applications to magnetic disk production, a donut shaped circular base material is used. A substrate provided with a ferromagnetic metal layer and the like described below, namely a magnetic recording medium, is rotated about a central axis during magnetic recording or playback, with a rotational speed of 3600 rpm to 15,000 rpm. During such rotation, a magnetic head flies across either the upper surface or the lower surface of the magnetic recording medium at a height of approximately 0.1 μm or several dozen nm. Furthermore, magnetic heads with an even lower flying height in the order of several nm are also being developed.

Consequently, a substrate 1 for which the flatness of the upper and lower surfaces, the parallel nature of the upper and lower surfaces, the circumferential waviness, and the surface roughness are suitably controlled is desirable.

(Seed Layer (Nucleation Layer))

A seed layer 2 according to the present invention is a layer which is provided for the purpose of controlling the crystal orientation and the crystal grain diameter of the metal underlayer 3 and the ferromagnetic metal layer 4. The seed layer is an important structural element in improving the recording and playback characteristics of the magnetic recording medium, particularly in those cases in which the substrate 1 is not a NiP—Al substrate, but is rather a glass substrate or the like.

A seed layer 2 according to the present invention, which functions as a nucleation layer, can utilize either an alloy incorporating at least Nb, or an alloy incorporating at least one element selected from the group consisting of V, Mo and W. Although there are no particular restrictions on the composition of the material, specific examples include materials such as Nb, V, W, Mo, NiNb, NiNbB, NiNbGe, CoMoCu, BCo, CoHf, CoSiMo, NiW, NiWB, NiWSi, NiV, and NiVB.

In cases in which an alloy comprising the aforementioned Nb, V, Mo or W together with another metallic element is used, the proportion of each element should preferably be within a range from 20 at % to 80 at %. If the proportion of an element exceeds the upper limit of the above range, then various problems arise including a reduction in the coercive force due to a deterioration in the lattice matching of the seed layer 2 with the metal underlayer 3 formed thereon, and a deterioration in the recording and playback characteristics of the magnetic recording medium due to an increase in size of the crystal grains of the ferromagnetic metal layer 4.

Furthermore, elemental proportions of 30 at % to 50 at % are even more desirable. By employing a structure which satisfies this narrower range, the lattice matching with the metal underlayer 3 can be optimized, and so a magnetic recording medium with a high coercive force can be obtained.

Alternatively, materials in which the aforementioned materials are combined in an alloy with at least one material selected from a group consisting of Ni, Co, Fe and Cu may also be used. Specific examples include alloys such as NiNb, NiW, NiV, NiMo, CoNb, CoW, CoV, CoMo, FeNb, FeW, FeV, FeMo, FeCu and CuNb.

If a structure is used which incorporates at least one element of the group consisting of Ni, Co, Fe and Cu, then an amorphous or a fine crystalline metal can be prepared with ease, and if this type of metal film is used as the seed layer, then the crystal grain diameter of both the underlayer and the magnetic layer fabricated on top of the seed layer can be miniaturized.

In those cases in which the seed layer 2 according to the present invention utilizes an alloy comprising a number of metallic elements, in order to ensure selection of the most favorable materials, the affinity for oxygen of the metallic element to be included in the alloy can be used as a reference. Specifically, elements should preferably be selected so that the difference in the standard free energy of formation for the oxides of the metallic elements is no more than 70 kcal/molO₂.

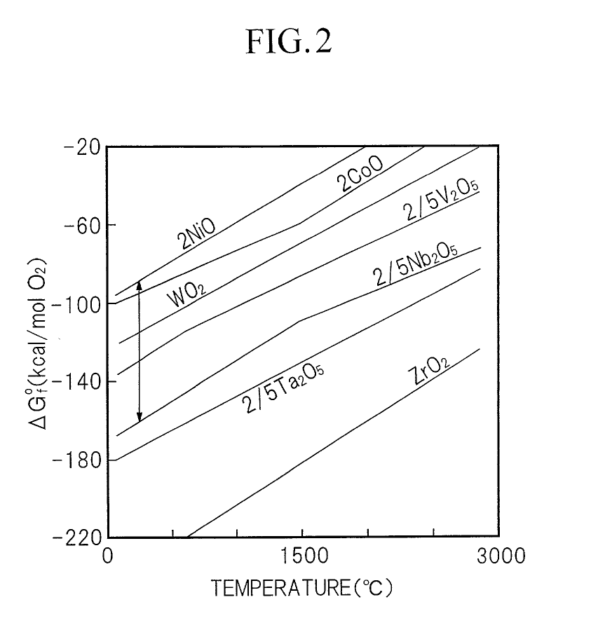

A specific example is described with reference to FIG. 2. FIG. 2 is a diagram showing the temperature characteristics of the standard free energy of formation for the oxides of a number of elements. As is evident from the diagram, if Nb is selected as one element, then the other element can be selected from elements including Ni, W, V and Co.

In addition, elements such as Cr, Ta, Al, Zr, B, Ti, Si, Mn, Hf, Pr, Ag, Sm and C may also be added to the aforementioned materials in quantities between 0.3 at % and 10 at %, provided such addition does not deleteriously effect the characteristics of the material. By using this type of structure, the miniaturization of the crystal grain diameter of the metal underlayer 3 and the ferromagnetic metal layer 4 formed on top of the seed layer can be promoted.

The film thickness of the seed layer 2 should preferably be from 2.5 nm to 500 nm. If the film thickness is less than 2.5 nm then the coercive force of the magnetic recording medium is insufficient and so high density recording becomes impossible. In contrast, if the film thickness exceeds 500 nm, then the crystal grain diameter of the seed layer 2 becomes excessively large making it difficult to obtain the desired recording and playback characteristics, and the film fabrication takes an excessive amount of time making production of the medium impractical.

In the magnetic recording medium of the embodiment shown in FIG. 1, oxygen is physically adsorbed onto the surface of the seed layer 2, at the interface 6 between the seed layer 2 and the metal underlayer 3. This adsorbed oxygen is formed following film fabrication of the seed layer 2 by exposing the surface of the seed layer 2 to an oxygen containing atmosphere, and not only reduces the crystal grain diameter of the metal underlayer 3 formed on top of the seed layer 2, but also suppresses variation in the crystal grain diameter of the metal underlayer 3. As a result, the crystal grains of the ferromagnetic metal layer 4 formed on top of the metal underlayer 3 can be miniaturized, and the medium noise can be reduced.

Furthermore, another method of achieving the same effects as described above comprises adding oxygen or nitrogen to the film fabrication gas for forming the seed layer 2. Alternatively, a structure in which nitrogen or air is physically adsorbed to the surface of the seed layer 2 can also be used. Yet another alternative involves addition of an oxide or a nitride to the seed layer.

(Metal Underlayer)

The metal underlayer 3 of a magnetic recording medium of the present embodiment should preferably comprise Cr or a Cr alloy. In cases in which a Cr alloy is used, alloys of Cr with Mo, W, Ti, V, Nb and Ta can be used. By using either Cr or a Cr alloy as the metal underlayer 3, a segregation effect can be caused within the ferromagnetic metal layer 4 formed on top of the metal underlayer 3. As a result, the magnetic interaction between crystal grains of the ferromagnetic metal layer 4 can be suppressed, enabling the normalized coercive force to be increased. Furthermore, the easy axis (c axis) of the ferromagnetic metal layer 4 formed on top of the metal underlayer 3 is also able to adopt a direction within the plane of the substrate. In other words, crystal growth of the ferromagnetic metal layer 4 is promoted in a direction which increases the coercive force within the plane of the substrate.

(Ferromagnetic Metal Layer)

A ferromagnetic metal layer 4 used in the present invention is a ferromagnetic metal layer with an hcp structure.

The material for forming the ferromagnetic metal layer 4 should preferably utilize a Co based ferromagnetic alloy comprising Co as a main constituent. Specific examples of such materials include CoCrNi, CoCrTa, CoCrPt, CoNiCrTa and CoCrPtTa. Furthermore, alloys in which one, or two or more elements selected from a group comprising B, N, O, Nb, Zr, Cu, Ge and Si are added to the above alloys may also be used.

In the present invention, by preparing the seed layer 2, the metal underlayer 3 and the ferromagnetic metal layer 4 in an ultra clean atmosphere which offers cleaner conditions than conventional film fabrication conditions (namely, an ultra clean process), the following two features can be realized.

(1) For a medium comprising a material in which the relationship between the saturated magnetization Ms and the anisotropic magnetic field Hk^{grain} of the ferromagnetic metal layer satisfies the condition 4πMs/Hk^{grain}≦1, a high normalized coercive force (Hc/Hk^{grain}) can be achieved with good stability, regardless of the crystal grain diameter of the ferromagnetic metal layer.

(2) Within the feature (1) described above, a medium in which the grain diameter of each of the crystal grains which make up the ferromagnetic metal layer is no more than 10 nm is able to offer an improved S/N ratio and a reduced degree of medium surface roughness.

The aforementioned normalized coercive force is the value obtained by dividing the coercive force Hc of the magnetic recording medium by the anisotropic magnetic field Hk^{grain}, and this value represents the degree of improvement in the magnetic isolation of the crystal grains. (“Magnetization Reversal Mechanism Evaluated by Rotational Hysteresis Loss Analysis for the Thin Film Media”, Migaku Takahashi, T. Shimatsu, M. Suekane, M. Miyamura, K. Yamaguchi and H. Yamasaki: IEEE Transactions on Magnetics, Vol. 28, 1992, p. 3285.)

As follows is a description of the production of a magnetic recording medium of the type of structure described above using sputtering techniques.

(Sputtering Method)

Examples of sputtering methods, which represent one example of a method of producing a magnetic recording medium according to the present invention, include carrier type sputtering methods in which a substrate is moved across in front of a target while a thin film is formed, and stationary type sputtering methods in which a substrate is fixed in front of a target and a thin film then formed.

The former carrier type sputtering method is advantageous for low cost magnetic recording media production because it is very applicable to mass production, whereas the latter stationary type sputtering method enables the production of magnetic recording media with superior recording and playback characteristics because the incident angle of the sputtering grains relative to the substrate is stable. However, the production of a magnetic recording medium according to the present invention is not necessarily limited to either a carrier type method or a stationary type method.

(Physical Adsorption of Oxygen and/or Nitrogen to the Surface of the Seed Layer)

In a method of producing a magnetic recording medium according to the present invention, it is preferable that treatment is conducted for physically adsorbing oxygen and/or nitrogen to at least the surface of the seed layer. This treatment is described in detail below.

In those cases in which oxygen and/or nitrogen is to be physically adsorbed onto only the surface of the seed layer, then following film fabrication of the seed layer, the surface of the seed layer is exposed to an atmosphere containing oxygen and/or nitrogen, which enables a predetermined quantity of oxygen or nitrogen to be adsorbed onto the surface. In this exposure treatment, the amount of adsorption onto the seed layer surface can be controlled by adjusting the partial pressure of the oxygen or nitrogen and the length of the exposure period. In cases where the materials described above are used as the seed layer, the amount of exposure should preferably be at least 25 L (Langmuir). 1 L corresponds with a 1 second exposure at 1×10⁻⁶ Torr or a 10 second exposure at 1×10⁻⁷ Torr, whereas 25 L corresponds with a 25 second exposure at 1×10⁻⁶ Torr or a 250 second exposure at 1×10⁻⁷ Torr.

The partial pressure of the oxygen or nitrogen and the exposure period used in actual production can be set to optimum values in accordance with the oxygen affinity of the material of the seed layer. Furthermore, the oxygen or nitrogen may also be diluted with a rare gas.

Alternatively, by using Ar or another rare gas to which oxygen and/or nitrogen has been added as the gas for film fabrication of the seed layer, the oxygen or nitrogen gas component can be physically adsorbed to the surface of the seed layer. In such a method, because oxygen and/or nitrogen is also incorporated into the internal sections of the seed layer, then depending on the material of the seed layer, addition of excess oxygen or nitrogen may result in a deterioration in crystallinity, or the generation of oxides or nitrides. Consequently, the amount of oxygen or nitrogen added should be restricted so that the flow ratio for the mixed gas comprising Ar or another rare gas is preferably no more than 0.2.

(Ultimate Vacuum of the Film Fabrication Chamber Used for Forming the Seed Layer, the Metal Underlayer and the Ferromagnetic Metal Layer)

Conventionally, the ultimate vacuum of a film fabrication chamber is positioned as one of the film fabrication factors which affect the value of the coercive force, depending on the material of the ferromagnetic metal layer which functions as the recording layer.

Particularly in a ferromagnetic metal layer which uses a Co based magnetic material which also incorporates Ta, it is thought that this effect is large in those cases where the aforementioned ultimate vacuum is low (for example, at the 10⁻⁶ to 10⁻⁷ Torr level). Consequently in the present invention, it is preferable that the formation of the seed layer, the metal underlayer and the ferromagnetic metal layer are conducted using an ultra clean process in which film fabrication is carried out under high vacuum conditions with an ultimate vacuum of no more than 3×10⁻⁹ Torr. If film fabrication of each of the aforementioned layers is conducted using such an ultra clean process, a high coercive force can be achieved even if the seed layer and the metal underlayer are extremely thin, and moreover by reducing the film thickness of the seed layer and the metal underlayer, the crystal grains of the ferromagnetic metal layer can be miniaturized, enabling an improvement in the recording and playback characteristics of the magnetic recording medium.

Examples of the impurities in the Ar gas used during film fabrication in the present invention include H₂O, O₂, CO₂, H₂, N₂, CₓH_{y}, H, C, O and CO. Impurities which have a particular effect on the amount of oxygen incorporated within a film can be assumed to be H₂O, O₂, CO₂, O and CO. Accordingly, the concentration of impurities in the present invention represents the sum total of H₂O, O₂, CO₂, O and CO incorporated within the Ar gas used for film fabrication. In other words, Ar gas with an impurity concentration of no more than 1 ppb refers to gas in which the sum total of H₂O, O₂, CO₂, O and CO is no more than 1 ppb.

However, for a magnetic recording medium structure according to the present invention, the above type of ultra clean process is not a necessity, and may be selected as necessary, depending on the desired characteristics for the target magnetic recording medium. Even in those cases where a conventional process in which the ultimate vacuum of the film fabrication chamber is at the 10⁻⁷ Torr level is used, the present invention is still able to achieve a magnetic recording medium with superior recording and playback characteristics.

### EXAMPLES

As follows is a more detailed description of the present invention based on a series of examples, although the present invention is not limited to the examples presented.

### Example 1

In this example, a magnetic recording medium comprising a seed layer 2, a metal underlayer 3 and a ferromagnetic metal layer 4 was prepared, as shown in FIG. 1.

Film fabrication was carried out using a direct current magnetron sputtering method, using a conventional process with a film fabrication chamber with an ultimate vacuum at the 10⁻⁷ Torr level and a process gas with an impurity concentration of no more than 1 ppm. During film fabrication, the substrate temperature was first raised to 250° C., and following heating of the substrate, a seed layer 2 was formed using an Ar flow rate of 100 sccm. Subsequently, the amount of oxygen exposure was increased from 0 L to 2500 L (Langmuir) and the surface of the seed layer 2 was exposed to this oxygen atmosphere. Finally, the Ar flow rate was set at 100 sccm, and a metal underlayer, a ferromagnetic metal layer and a protective layer were formed, in that order.

In this example, the substrate was a disc shaped glass substrate with a surface roughness of less than 0.3 nm. A Ni-(40 at %)Nb target was used as the target for the seed layer, a Cr-(10 at %)Mo target was used as the target for the metal underlayer, a Co-(24 at %)Cr-(8 at %)Pt-(4 at %)B target was used as the target for the ferromagnetic metal layer 4, and a carbon target was used as the target for the protective layer.

Although in this example direct current magnetron sputtering was used as the method of fabricating each of the aforementioned layers, other film fabrication methods such as RF sputtering, laser vapor deposition, or ion beam film fabrication could also be used.

The preparation conditions for the magnetic recording medium according to this Example 1 are shown below in Table 1.

TABLE 1

| | |
|---|---|
| Film fabrication method | Direct current magnetron sputtering |
| Substrate | Crystallized glass |
| Surface state of substrate | Ra <0.3 nm |
| Ultimate vacuum of film fabrication chamber | <1 × 10⁻⁶ Torr |
| Process gas | Ar |
| Impurity concentration of Ar gas | <1 ppm |
| Ar gas flow rate | 100 sccm |
| Surface temperature of substrate | 250° C. |
| Seed layer | Ni-(40 at %)Nb |
| Seed layer thickness | 25 nm |
| Amount of oxygen exposure on seed layer surface | 0 L to 2500 L (Langmuir) |
| Metal underlayer | Cr-(10 at %)Mo |
| Metal underlayer thickness | 20 nm |
| Ferromagnetic metal layer | Co-(24 at %)Cr-(8 at %)Pt-(4 at %)B |
| Ferromagnetic metal layer thickness | 20 nm |
| Protective layer | Carbon (7 nm) |

### Comparative Example

Next, for the purposes of comparison, a seed layer 2 of film thickness 25 nm was formed using a Ni-(50 at %)Al target, and a magnetic recording medium was prepared without exposing the surface of the seed layer to oxygen. With the exception of these alterations to the structure of the seed layer and the oxygen exposure conditions, the preparation was conducted in the same manner as the Example 1.

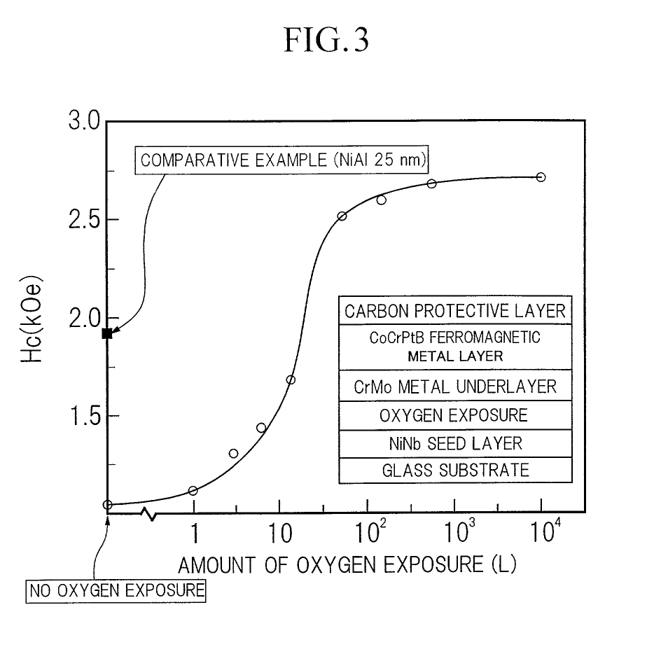

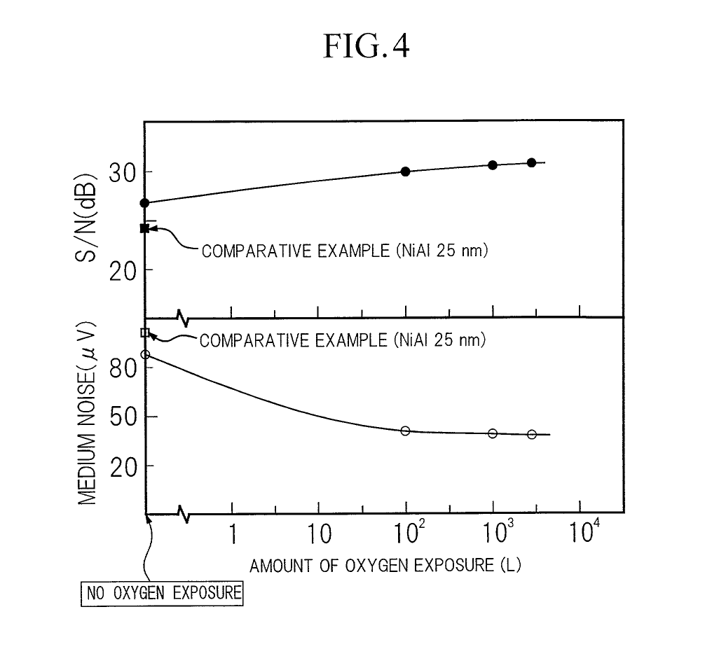

The coercive force for the magnetic recording media prepared in the aforementioned Example 1 and the comparative example were measured using VSM (vibrating sample magnetometer: BHV-35 manufactured by RikenDenshi Co. Ltd). Furthermore, the recording and playback characteristics of the magnetic recording media were measured using a magnetic head with a very large magnetic resistance element as the playback element. Measurement of the recording and playback characteristics were performed with a track recording density of 420 kFCI (the equivalent of a recording density of 16.8 Gb/in² in the case of a track density of 40 KTPI). The results of the measurements are shown in FIG. 3 and FIG. 4.

FIG. 3 is a graph showing the magnetic characteristics of the Example 1 and the comparative example, wherein the horizontal axis represents the amount of oxygen exposure (L: Langmuir), and the vertical axis represents the coercive force (Oe). FIG. 4 is a graph showing the recording and playback characteristics of the Example 1 and the comparative example, wherein the horizontal axis represents the amount of oxygen exposure (L), and the vertical axis represents the S/N ratio (dB) and the medium noise (μV). Furthermore, the curve towards the top of FIG. 4 represents the oxygen exposure dependency of the S/N ratio of the magnetic recording medium of the Example 1, and the curve towards the bottom of FIG. 4 represents the oxygen exposure dependency of the medium noise of the magnetic recording medium of the Example 1.

As is evident from these diagrams, both the coercive force and the S/N ratio for the magnetic recording medium of the Example 1, which comprises a seed layer 2 of Ni-(40 at %)Nb, are superior to the corresponding values for the magnetic recording medium of the comparative example which comprises a NiAl seed layer 2. Furthermore it is also evident that provided oxygen is physically adsorbed onto the surface of the seed layer 2, a magnetic recording medium with a high coercive force and a superior S/N ratio can be obtained.

### Example 2

Next, a magnetic recording medium was prepared using a Ni-(40 at %)Nb target for the film fabrication of the seed layer 2, and using a mixed gas comprising oxygen added to Ar as the film fabrication gas for this seed layer 2. In this example, the film thickness of the seed layer 2 was set at 25 nm, and the oxygen flow rate of the mixed gas was varied within a range between 0 sccm and 10 sccm. With the exception of the above changes, and not exposing the surface of the seed layer 2 to oxygen, the film fabrication conditions for formation of the metal underlayer 3 and the ferromagnetic metal layer 4 and the like were identical with those used in the Example 1. The film fabrication conditions for the magnetic recording medium according to this Example 2 are shown in Table 2.

TABLE 2

| | |
|---|---|
| Film fabrication method | Direct current magnetron sputtering |
| Substrate | Crystallized glass |
| Surface state of substrate | Ra <0.3 nm |
| Ultimate vacuum of film fabrication chamber | <1 × 10⁻⁶ Torr |
| Process gas | Ar |
| Impurity concentration of Ar gas | <1 ppm |
| Ar gas flow rate | 100 sccm |
| Surface temperature of substrate | 250° C. |
| Seed layer | Ni-(40 at %)Nb |
| Seed layer thickness | 25 nm |
| Oxygen flow rate during seed layer fabrication | 0 sccm to 10 sccm |
| Metal underlayer | Cr-(10 at %)Mo |
| Metal underlayer thickness | 20 nm |
| Ferromagnetic metal layer | Co-(24 at %)Cr-(8 at %)Pt-(4 at %)B |
| Ferromagnetic metal layer thickness | 20 nm |
| Protective layer | Carbon (7 nm) |

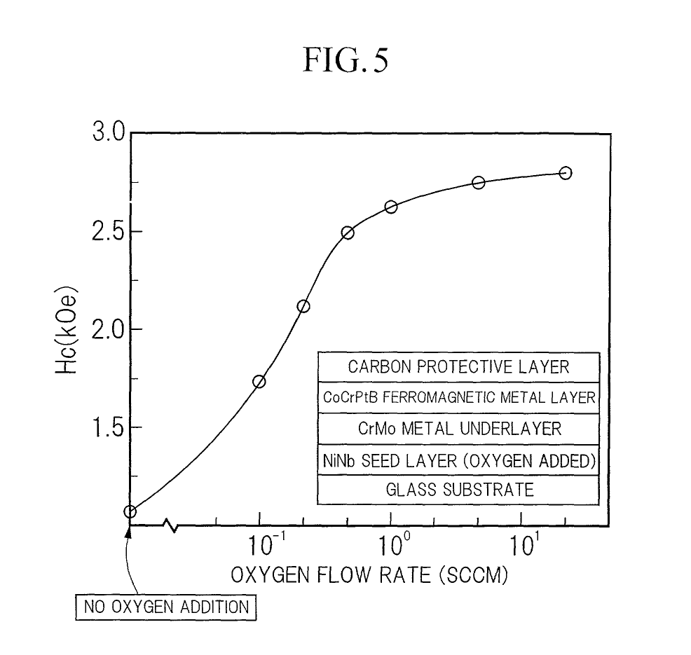

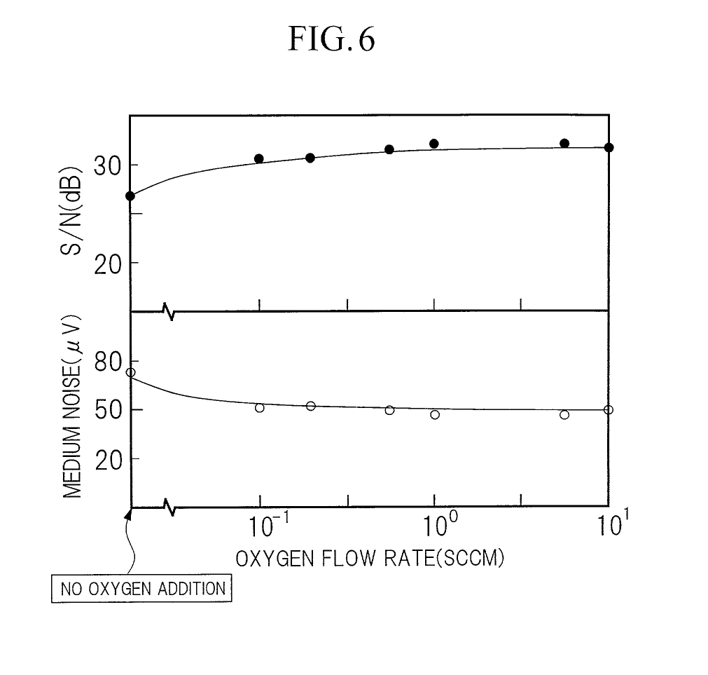

The magnetic characteristics and the recording and playback characteristics of the magnetic recording medium prepared according to this Example 2 were measured in an identical manner to that described above for the Example 1. The results of the measurements are shown in FIG. 5 and FIG. 6. FIG. 5 is a graph showing the magnetic characteristics of the Example 2 and the comparative example, wherein the horizontal axis represents the oxygen flow rate (sccm), and the vertical axis represents the coercive force (Oe). FIG. 6 is a graph showing the recording and playback characteristics of the Example 2 and the comparative example, wherein the horizontal axis represents the oxygen flow rate (sccm), and the vertical axis represents the S/N ratio (dB) and the medium noise (μV). Furthermore, the curve towards the top of FIG. 6 represents the oxygen flow rate dependency of the S/N ratio of the magnetic recording medium of the Example 2, and the curve towards the bottom of FIG. 6 represents the oxygen flow rate dependency of the medium noise of the magnetic recording medium of the Example 2.

As is evident from these diagrams, addition of oxygen to the film fabrication gas causes a reduction in the medium noise, and as a result an improvement was observed in the S/N ratio. It is thought that this observation is due to the oxygen added to the film fabrication gas promoting miniaturization of the crystal grains of the seed layer, and as a result producing a miniaturization of the crystal grains of the metal underlayer and the ferromagnetic metal layer.

As can be seen in Table 1 and Table 2, in the aforementioned Example 1 and the Example 2, the seed layer 2, the metal underlayer 3 and the ferromagnetic metal layer 4 were formed using a conventional film fabrication process, wherein the ultimate vacuum of the film fabrication chamber was at the 10⁻⁷ Torr level, and the Ar gas impurity concentration was approximately 1 ppm. However as described above, magnetic recording media with superior recording and playback characteristics were still obtained, confirming that magnetic recording media with superior characteristics can be produced in a film fabrication chamber for which the ultimate vacuum is comparatively low.

(Magnetic Recording Device)

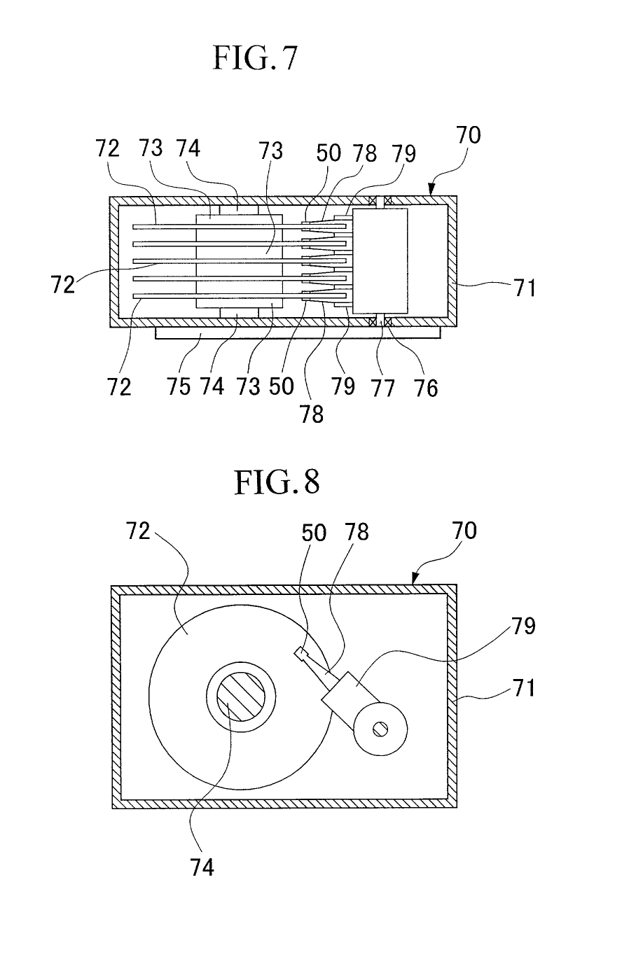

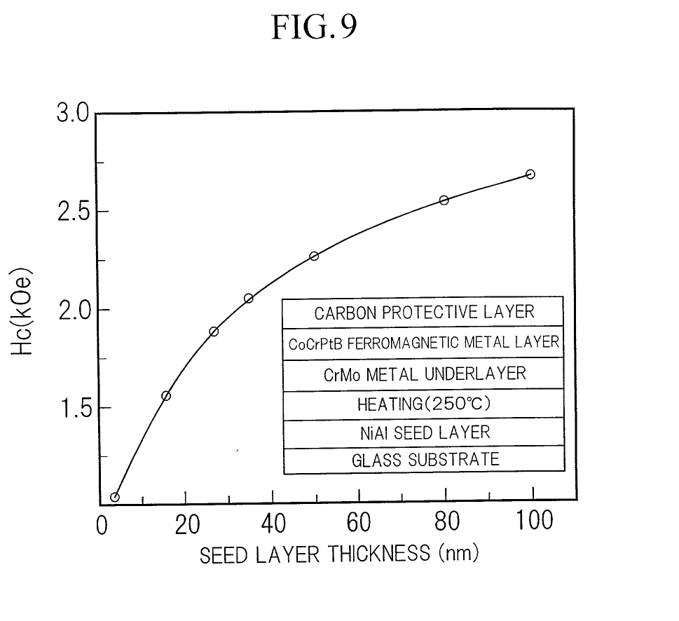

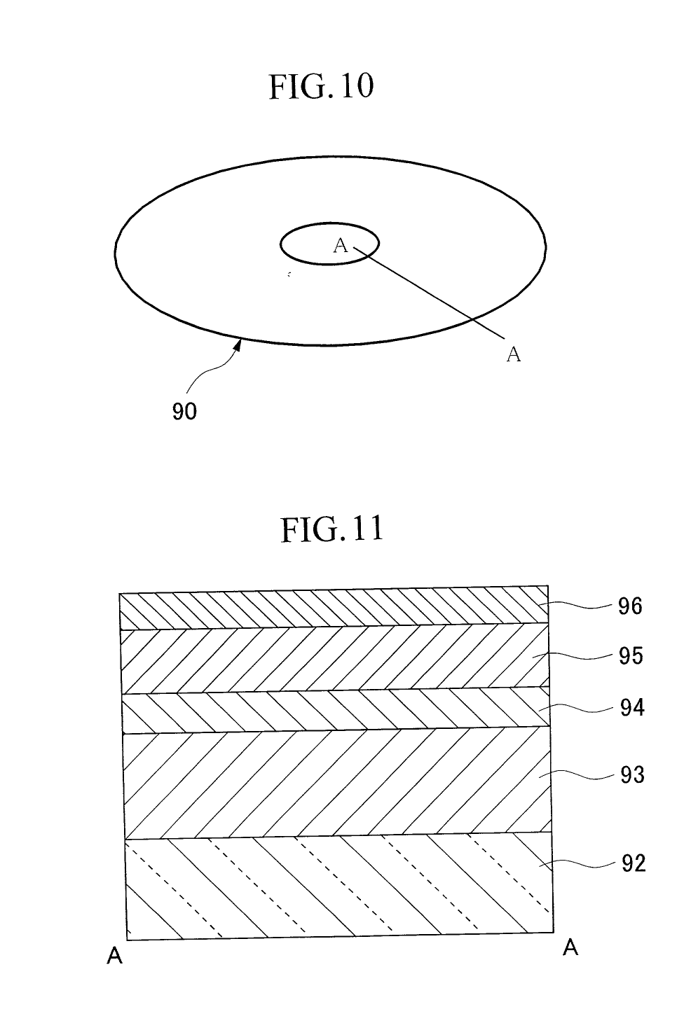

As follows is a description of a magnetic recording device according to the present invention with reference to the drawings. FIG. 7 is a side view showing a hard disk device as an example of a magnetic recording device according to the present invention, and FIG. 8 is a plan view of a magnetic recording layer shown in FIG. 7. In FIG. 7 and FIG. 8, 50 represents a magnetic head, 70 the hard disk device, 71 an external casing, 72 a magnetic recording medium, 73 a spacer, 79 a swing arm, and 78 a suspension.

The hard disk device 70 according to this embodiment houses magnetic recording media of the present invention which have been described above.

The external form of the hard disk device 70 is formed by the rectangular external casing 71, which contains sufficient internal space for housing the circular magnetic recording media 72 and the magnetic heads 50 and the like. A number of magnetic recording media 72 and alternating spacers 73 are passed over a spindle 74 inside the external casing 71. Furthermore, a bearing (not shown in the drawing) for the spindle 74 is provided within the external casing 71, and a motor 75 for rotating the spindle 74 is provided outside the external casing 71. With such a construction, the number of layers of magnetic recording media 72 are stacked up on top of one another with the spacers 73 providing sufficient space between layers for the magnetic heads 50 to move in and out, and the magnetic recording media 72 are able to rotate freely about the spindle 74.

Inside the external casing 71 and positioned alongside the magnetic recording media 72 is provided a rotational axis 77 known as a rotary actuator which is supported in an arrangement parallel with the spindle 74 by a bearing 76. A number of swing arms 79 are attached to this rotational axis 77 so as to extend out into the space between each of the various magnetic recording media 72. A magnetic head 50 is attached to the tip of each swing arm 79 via an elongated triangular plate shaped suspension 78 which is fixed so as to be inclined towards the surface of the magnetic recording media 72 positioned above and below the swing arm. The magnetic heads 50 each comprise a recording element for writing information onto the magnetic recording media 72 and a playback element for reading information from the magnetic recording media 72, although these details are not shown in the diagram.

As described above, each of the magnetic recording media 72 comprises a non-magnetic substrate, and a seed layer (nucleation layer), a metal underlayer and a ferromagnetic metal layer formed on top of the substrate, wherein the seed layer comprises at least one element selected from the group consisting of Nb, V, Mo and W. Consequently, the magnetic recording media within the magnetic recording device display a high coercive force and a superior S/N ratio, as described above.

According to the construction described above, the magnetic recording medium 72 is rotated, and the magnetic head 50 is moved across the magnetic recording medium 72 in a radial direction through the movement of the swing arm 79, enabling the magnetic head 50 to be moved to any position above the magnetic recording medium 72.

In a hard disk device 70 of the above construction, by rotating the magnetic recording medium 72 while moving the swing arm 79 and the magnetic head 50, and then applying a magnetic field generated at the magnetic head 50 to the ferromagnetic metal layer of the magnetic recording medium 72, the desired magnetic information can be written to the magnetic recording medium 72. Furthermore, by moving the swing arm 79 and moving the magnetic head 50 to any position on the magnetic recording medium 72, and then using the playback element of the magnetic head 50 to detect the leakage magnetic field from the ferromagnetic metal layer of the magnetic recording medium 72, readout of the magnetic information can be carried out.

When the writing and reading of magnetic information is performed in this manner, provided the magnetic recording medium 72 displays the high coercive force and superior recording and playback characteristics described above, then a hard disk device 70 can be provided in which the recording and playback of magnetic information with a high recording density can be performed with good stability.

The hard disk device 70 described above based on FIG. 6 and FIG. 7 shows merely one example of a magnetic recording device, and the number of magnetic recording medium discs mounted in the magnetic recording device may be any number from one upwards, and similarly the number of magnetic heads provided in the device may also be any number from one upwards. In addition, the shape of the swing arms 79 and the drive system used are not limited to those shown in the drawings, and needless to say, other drive systems such as linear drive systems are also possible.

What is claimed is:

1. A magnetic recording medium comprising a non-magnetic substrate, and a nucleation layer, a metal underlayer, and a ferromagnetic metal layer for recording magnetic information, formed either one of directly and indirectly on top of said non-magnetic substrate, wherein
said nucleation layer comprises an alloy incorporating at least Nb.

2. A magnetic recording medium according to claim 1, wherein a proportion of Nb within said nucleation layer is from 20 at % to 80 at %.

3. A magnetic recording medium according to claim 1, wherein a proportion of Nb within said nucleation layer is from 30 at % to 50 at %.

4. A magnetic recording medium comprising a non-magnetic substrate, and a nucleation layer, a metal underlayer, and a ferromagnetic metal layer for recording magnetic information, formed either one of directly and indirectly on top of said non-magnetic substrate, wherein
said nucleation layer comprises an alloy incorporating at least one element selected from a group consisting of V, Mo and W.

5. A magnetic recording medium according to claim 4, wherein proportions of any of V, Mo and W within said nucleation layer are each from 20 at % to 80 at %.

6. A magnetic recording medium according to claim 4, wherein proportions of any of V, Mo and W within said nucleation layer are each from 30 at % to 50 at %.

7. A magnetic recording medium according to either one of claim 1 and claim 4, wherein said nucleation layer comprises at least one element selected from a group consisting of Ni, Co, Fe and Cu.

8. A magnetic recording medium according to either one of claim 1 and claim 4, wherein a film thickness of said nucleation layer is from 2.5 nm to 500 nm.

9. A method of producing a magnetic recording medium comprising steps for forming, by film fabrication methods, at least a nucleation layer, a metal underlayer, and a ferromagnetic metal layer on top of a non-magnetic substrate, wherein p1 said nucleation layer is fabricated from an alloy incorporating at least Nb, and
a step is provided for physically adsorbing oxygen and/or nitrogen onto at least a surface of said nucleation layer.

10. A method of producing a magnetic recording medium comprising steps for forming, by film fabrication methods, at least a nucleation layer, a metal underlayer, and a ferromagnetic metal layer on top of a non-magnetic substrate, wherein
said nucleation layer is fabricated from an alloy incorporating at least one element selected from a group consisting of V, Mo and W, and
a step is provided for physically adsorbing oxygen and/or nitrogen onto at least a surface of said nucleation layer.

11. A method of producing a magnetic recording medium according to either one of claim 9 and claim 10, wherein a gas used for film fabrication of said nucleation layer is a mixed gas comprising either one of Ar and another rare gas to which either one of oxygen and nitrogen has been added.

12. A method of producing a magnetic recording medium according to either one of claim 9 and claim 10, wherein
said step for physically adsorbing oxygen and/or nitrogen onto at least said surface of said nucleation layer is a step for exposing said surface of said nucleation layer to an atmosphere incorporating oxygen and/or nitrogen.

13. A method of producing a magnetic recording medium according to either one of claim 9 and claim 10, wherein an amount of oxygen exposure onto said surface of said nucleation layer is at least 25 Langmuir.

14. A method of producing a magnetic recording medium according to either one of claim 9 and claim 10, wherein at least one layer amongst said nucleation layer, said metal underlayer and said ferromagnetic metal layer is fabricated in a film fabrication chamber with an ultimate vacuum of no more than 3×10⁻⁹ Torr, using a film fabrication gas with an impurity concentration of no more than 1 ppb.

15. A magnetic recording device comprising a magnetic recording medium according to any one of claim 1 through claim 8, a drive section for driving said magnetic recording medium, and a magnetic head for carrying out recording and playback of magnetic information, wherein said magnetic head performs recording and playback of magnetic information on a moving said magnetic recording medium.
